(19) United States
(12) Patent Application Publication
(10) Pub. No.: US 2010/0239913 A1
(43) Pub. Date: Sep. 23, 2010

(54) EXTERNAL STABILIZATION OF CARBON FOAM

(76) Inventors: Kurtis C. Kelley, Washington, IL (US); Matthew J. Maroon, Metamora, IL (US); Ellen McCarthy, Pekin, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/377,871

(22) PCT Filed: Aug. 31, 2006
(86) PCT No.: PCT/US06/34161

§ 371 Date: Feb. 18, 2009

(51) Int. Cl. H01M 4/58; B05D 5/12; H01M 4/04

(52) U.S. Cl. 429/231.8; 427/58

(57) ABSTRACT

According to one aspect, the present disclosure is directed toward an electrode plate for an energy storage device. The electrode plate may include a carbon foam current collector and an external restraint structure. A chemically active material may be disposed on the carbon foam current collector.

### DESCRIPTION OF THE INVENTION

1. Technical Field

The present invention relates to the use of carbon foam in energy storage devices and, more particularly, to the external stabilization of carbon foam current collectors in an energy storage device.

2. Background

Electrochemical batteries, including, for example, lead acid batteries, rely upon chemical reactions to produce electrochemical potential differences. Certain types of these batteries are known to include at least one positive current collector, at least one negative current collector, and an electrolytic solution including, for example, sulfuric acid (H2SO4) and distilled water. Ordinarily, both the positive and negative current collectors in a lead acid battery are constructed from lead. The role of these lead current collectors is to transfer electric current to and from the battery terminals during the discharging and charging processes. Storage and release of electrical energy in lead acid batteries is enabled by chemical reactions that occur in a paste disposed on the current collectors. The positive and negative current collectors, once coated with this paste, are referred to as positive and negative plates, respectively.

While lead acid batteries have been widely used in various applications, a notable limitation on the durability and service life of lead acid batteries is corrosion of the lead current collector of the positive plate. For example, once the sulfuric acid electrolyte is added to the battery and the battery is charged, the current collector of each positive plate is continually subjected to corrosion due to its exposure to sulfuric acid and to the anodic potentials of the positive plate. As the lead current collector corrodes, lead dioxide is formed from the lead source metal of the current collector. An effect of this corrosion of the positive plate current collector is volume expansion, since lead dioxide has a greater volume than lead. Volume expansion induces mechanical stresses on the current collector that deform and stretch the current collector. At a total volume increase of the current collector of approximately 4% to 7%, the current collector may fracture. As a result, battery capacity drops, and eventually, the battery will reach the end of its service life. Additionally, at advanced stages of corrosion, internal shorting within the current collector and rupture of the cell case can occur. These corrosion effects may lead to failure of one or more of the cells within the battery.

One method of extending the service life of a lead acid battery is to increase the corrosion resistance of the current collectors and other electrically conductive components in the battery by including electrically conductive carbon in the current collectors and components. Because carbon does not oxidize at the temperatures at which lead acid batteries generally operate, some of these methods have involved using carbon in various forms to slow or prevent the detrimental corrosion process in lead acid batteries. For example, carbon foam has been proposed as a current collector material for use in lead acid batteries.

Use of carbon foam (e.g., graphite foam) as a current collector can increase the corrosion resistance and surface area of the current collector over lead current collector grids. This additional surface area of the current collectors may increase the specific energy and power of the battery, thereby enhancing its performance. However, among the network of pores formed in the foam, there may exist a plurality of defects that can allow intercalation of electrically charged ions of the electrolytic solution into the structure of the foam. The intercalation of the ions can cause internal damage such as separation and delamination between foam layers, and ultimately lead to reduced performance or premature failure of the current collector. The effects of intercalation may be particularly prevalent when the carbon foam structure includes graphite foam.

Thus, there is a need for a structure, such as a structural restraint system, that can improve the resistance of carbon foam to intercalation of ions and the harmful effects of this phenomenon. The presently disclosed embodiments are directed toward meeting this need.

### SUMMARY OF THE INVENTION

According to one aspect, the present disclosure is directed toward an electrode plate for an energy storage device. The electrode plate may include a carbon foam current collector and an external restraint structure. A chemically active material may be disposed on the carbon foam current collector.

According to another aspect, the present disclosure is directed toward an energy storage device. The energy storage device may include a housing, a positive terminal, a negative terminal, and at least one cell disposed within the housing. Each cell may include an electrolytic solution, at least one positive plate, and at least one negative plate. The at least one positive plate may include a carbon foam current collector and an external restraint structure. A chemically active material may be disposed on the carbon foam current collector.

According to yet another aspect, the present disclosure is directed toward a method for making an electrode plate of an energy storage device. The method may include providing a carbon foam current collector, applying a polymer-based external restraint structure, and applying a chemically active material to the carbon foam current collector.

### BRIEF DESCRIPTION OF THE DRAWINGS

The accompanying drawings, which are incorporated in and constitute a part of this specification, provide diagrammatic representation of the disclosed embodiments and together with the description, serve to explain the principles of the invention. In the drawings:

FIG. 1 provides a diagrammatic representation of an energy storage device in accordance with an exemplary disclosed embodiment;

FIG. 2 provides a diagrammatic representation of an electrode plate in accordance with an exemplary disclosed embodiment;

FIG. 3 is a diagrammatic representation of a restraint structure in accordance with an exemplary disclosed embodiment;

FIG. 4 is a flow diagram depicting an exemplary method for making an electrode plate in accordance with an exemplary disclosed embodiment;

FIG. 5 is a diagrammatic representation of a restraint structure in accordance with an exemplary disclosed embodiment;

FIG. 6 is a diagrammatic representation of a restraint structure in accordance with an exemplary disclosed embodiment;

FIG. 7A is a diagrammatic representation of a restraint structure in accordance with an exemplary disclosed embodiment;

FIG. 7B is a diagrammatic representation of a restraint structure in accordance with an exemplary disclosed embodiment.

### DESCRIPTION OF THE EMBODIMENTS

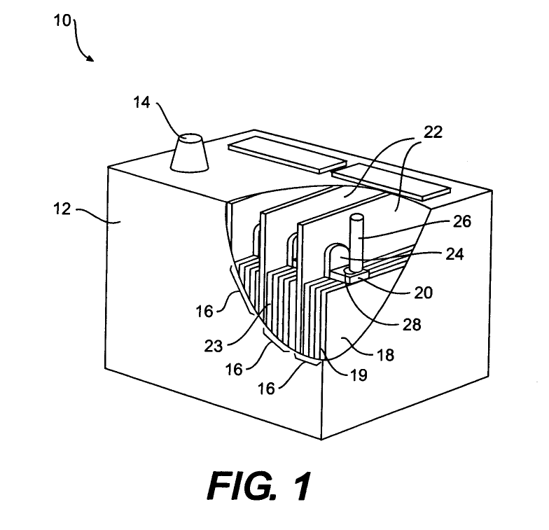

FIG. 1 provides a diagrammatic illustration of an energy storage device 10, according to an exemplary disclosed embodiment. Energy storage device 10 may include various types of batteries. For example, in one embodiment, energy storage device 10 may include a lead acid battery. Other battery chemistries, however, may be used, such as those based on nickel, lithium, sodium-sulfur, zinc, metal hydrides or any other suitable chemistry or materials that can be used to provide an electrochemical potential.

As illustrated in FIG. 1, energy storage device 10 may include a housing 12, terminals 14 (only one shown), and cells 16. Each cell 16 may include one or more positive plates 18 and one or more negative plates 19. In a lead acid battery, for example, positive plates 18 and negative plates 19 may be stacked in an alternating fashion. In each cell 16, a bus bar 20 may be provided to connect positive plates 18 together. A similar bus bar (not shown) may be included to connect negative plates 19 together.

Energy storage device 10 may also include aqueous or solid electrolytic materials that at least partially fill a volume between positive plates 18 and negative plates 19. In a lead acid battery, for example, the electrolytic material may include an aqueous solution of sulfuric acid and water. Nickel-based batteries may include alkaline electrolyte solutions that include a base, such as potassium hydroxide, mixed with water. It should be noted that other acids and other bases may be used to form the electrolytic solutions of the disclosed batteries.

Each cell 16 may be electrically isolated from adjacent cells by a cell separator 22. Moreover, positive plates 18 may be separated from negative plates 19 by a plate isolator 23. Both cell separators 22 and plate isolators 23 provide electrical separation of plates, while allowing the flow of electrolyte and/or ions produced by electrochemical reactions in energy storage device 10. Therefore, cell separators 22 and plate isolators 23 may be made from electrically insulating yet porous materials or materials conducive to ionic transport, such as fiberglass, for example.

Depending on the chemistry of energy storage device 10, each cell 16 will have a characteristic electrochemical potential. For example, in a lead acid battery used in automotive and other applications, each cell may have a potential of about 2 volts. Cells 16 may be connected in series to provide the overall potential of the battery. As shown in FIG. 1, an electrical connector 24 may be provided to connect positive bus bar 20 of one cell 16 to a negative bus bar of an adjacent cell. In this way, six lead acid cells may be linked together in series to provide a desired total potential of about 12 volts, for example. Alternative electrical configurations may be possible depending on the type of battery chemistry employed and the total potential desired.

Once the total desired potential has been provided using an appropriate configuration of cells 16, this potential may be conveyed to terminals 14 on housing 12 using terminal leads 26. These terminal leads 26 may be electrically connected to any suitable electrically conductive components present in energy storage device 10. For example, as illustrated in FIG. 1, terminal leads 26 may be connected to positive bus bar 20 and to a negative bus bar of another cell 16, respectively. Each terminal lead 26 may establish an electrical connection between a terminal 14 on housing 12 and a corresponding positive bus bar 20 or negative bus bar (or other suitable electrically conductive elements) in energy storage device 10.

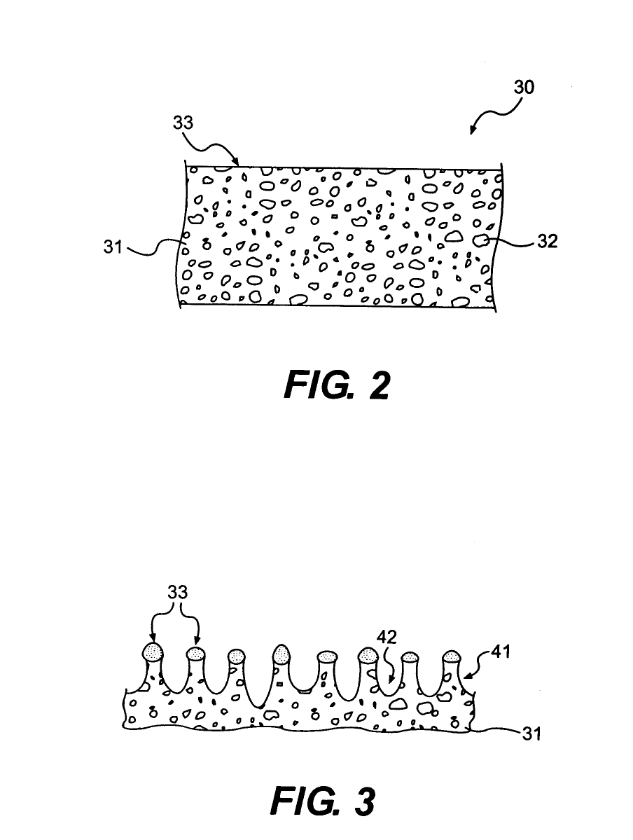

FIG. 2 illustrates a positive electrode plate 30 according to an exemplary disclosed embodiment. Electrode plate 30 may each include a current collector 31. Current collector 31 may be formed from carbon foam having an open pore structure. As illustrated in FIG. 2, carbon foam current collector 31 may include a plurality of pores 32. Current collectors composed of carbon foam may exhibit more than 2000 times the amount of surface area provided by conventional current collectors. As a result, an energy storage device having one or more carbon foam current collectors 31, as illustrated in FIG. 2, may offer improved specific energy values, specific power values, and charge/discharge rates, as compared to traditional configurations not including carbon foam current collectors.

In addition, a chemically active material (not shown) may be disposed on carbon foam current collector 31. The composition of the chemically active material may depend on the chemistry of energy storage device 10. In a lead acid battery, for example, the active material may include an oxide or salt of lead. As additional examples, the anode plates (i.e., positive plates) of nickel cadmium (NiCd) batteries may include a cadmium hydroxide (Cd(OH)2) active material; nickel metal hydride batteries may include a lanthanum nickel (LaNi5) active material; nickel zinc (NiZn) batteries may include a zinc hydroxide (Zn(OH)2) active material; and nickel iron (NiFe) batteries may include an iron hydroxide (Fe(OH)2) active material. In all of the nickel-based batteries, the chemically active material on the cathode (i.e., negative) plate may be nickel hydroxide. As previously mentioned, the role of current collector 31 is to collect and transfer the electric current generated by the electrochemical reactions that, at least in some battery chemistries, occur in chemically active material during the discharging and charging processes. Because of the increased surface area of carbon foam current collector 31 due to the plurality of pores 32, chemically active material can effectively penetrate into the open pore structure of carbon foam current collector 31.

In one embodiment, carbon foam material used in current collector 31 may include from about 4 to about 50 pores per centimeter and an average pore size of at least about 200 micrometers. In other embodiments, however, the average pore size may be smaller. For example, in certain embodiments, the average pore size may be at least about 40 micrometers. In still other embodiments, the average pore size may be at least about 20 micrometers. While reducing the average pore size of the carbon foam material may have the effect of increasing the effective surface area of the material, average pore sizes below 20 micrometers may impede or prevent penetration of chemically active material into pores of carbon foam material.

Regardless of the average pore size, a total porosity value for carbon foam may be at least 60%. In other words, at least 60% of the volume of carbon foam structure may be included within pores 32. Carbon foam materials may also have total porosity values less than 60%. For example, in certain embodiments, carbon foam may have a total porosity value of at least 30%.

Moreover, carbon foam may have an open porosity value of at least 90%. Therefore, at least 90% of pores 32 are open to adjacent pores such that the network of pores 32 forms a substantially open network. This open network of pores 32 may allow the active material deposited on each current collector 31 to penetrate within the carbon foam structure. In addition to the network of pores 32, carbon foam includes a web of structural elements that provide support for carbon foam. In total, the network of pores 32 and the structural elements of the carbon foam may result in a density of less than about 0.6 g/cm³ for the carbon foam material.

Due to the conductivity of the carbon foam of the present disclosure, current collectors 31 can efficiently transfer current to and from battery terminals 14, or any other conductive elements providing access to the electrical potential of battery 10. In certain forms, carbon foam may offer sheet resistivity values of less than about 1 ohm-cm. In other forms, carbon foam may have sheet resistivity values of less than about 0.75 ohm-cm.

In certain disclosed embodiments, the carbon foam may include graphite foam. Density and pore structure of graphite foam may be similar to carbon foam. A primary difference between graphite foam and carbon foam is the orientation of carbon atoms that make up the structural elements. For example, in carbon foam, carbon may be at least partially amorphous. In graphite foam, however, the carbon tends to be ordered into a layered structure. Because of the ordered nature of the graphite structure, graphite foam may offer higher conductivity than carbon foam. Graphite foam may exhibit electrical resistivity values of between about 100 micro-ohm-cm and about 2,500 micro-ohm-cm.

Within the carbon foam structure, particularly in the graphite foam structure, there may exist a plurality of layers. When the carbon foam is exposed to the electrically charged ions in an electrolytic solution, the ions may intercalate between the layers of the foam structure through surface defects and discontinuities that may exist among the network of open pores. The ions may act like a wedge being driven into the carbon foam structure, pulling the layers apart and causing internal damage. Intercalation of the ions may eventually cause separation of the foam layers within the carbon foam structure, which can lead to cracking and, ultimately, failure of the carbon foam as a current collector. In order to prevent or minimize intercalation of electrically charged ions of the electrolytic solution into the structure of carbon foam, an external restraint 33 may be disposed on the outer surface of carbon foam current collector 31. The external restraint may physically hold the layers of the foam structure together, particularly in layers adjacent to the restraint structure, and stabilize the carbon foam against occurrences of intercalation. Depending on its configuration, the external restraint may be effective in stabilizing carbon foam of varying thicknesses. In one embodiment, external restraint 33 may stabilize carbon foam layers having thickness of up to 1 to 2 mm. Stabilization of carbon foam of thicknesses greater than 2 mm, however, may also be accomplished by, for example, adjusting the thickness and/or material properties of external restraint 33.

One such graphite foam, under the trade name PocoFoam™, is available from Poco Graphite, Inc. PocoFoam™ is very anisotropic due to the ordered layers of carbon atoms. In preparing a bulk PocoFoam™ material for use in energy storage device, the bulk PocoFoam™ material may be cut into sheets or plates having two large primary surfaces and four edge surfaces. As the bulk foam is cut in a direction that is perpendicular to a plane of the ordered layers of carbon atoms in the foam, the primary surfaces of the PocoFoam™ sheets may contain a majority of the surface defects present, and the edge surfaces may contain fewer surface defects. Application of external restraint 33 to the primary surfaces of the carbon foam current collector can maximize the effectiveness of the restraint in minimizing intercalation of ions into the foam through surface defects and discontinuities existing on the primary surfaces.

The external restraint 33 disposed on the carbon foam current collector 31 may be porous to allow transport of various substances, ions, etc. through external restraint 33. For example, external restraint 33 may allow ions from the electrolytic solution of a battery to pass through and interact with the active material disposed on current collector 31.

A variety of materials may be used to produce external restraint 33. Any acid resistant material that is chemically stable in a battery environment can be used to form external restraint 33. For example, external restraint 33 may be produced from a variety of non-conductive materials including polymers, such as styrene, PVC, ABS, polyethylene, polypropylene, among others. In other embodiments, conductive materials such as metals can be used. The external restraint structure may be physically bonded to the surface of the current collector using an adhesive. Alternatively, the external restraint may be secured onto the current collector by sewing or any other suitable bonding or attaching technique. The external restraint may be configured in many different ways, such as a web structure, a mesh, grids, etc.

FIG. 3 illustrates diagrammatically an exemplary restraint structure 33 disposed on a portion of the outer surface of the carbon foam current collector 31. The outer surfaces of the carbon foam may include a plurality of ridges 41 and voids 42, wherein the voids 42 may be created by pores of the carbon foam that intersect the outer surface, and the ridges 41 may correspond to structures of the carbon foam found adjacent to the voids on the outer surface of the carbon foam. In one exemplary embodiment, external restraint 33 may include a structure formed on some or all of the ridges on the outer surface of the carbon foam. The voids may be left substantially free of the material used to form the external restraint. By disposing restraint 33 on the ridges of the outer surface of the carbon foam, the restraint may take on a web-like structure. The web-like restraint structure may allow interaction between the electrolytic solution and the chemically active material disposed on carbon foam current collector 31. In a reliability test, it has been found that an embodiment having a restraint as represented by FIG. 3 had more than a four hundred fold increase in service life as compared to an unrestrained carbon foam.

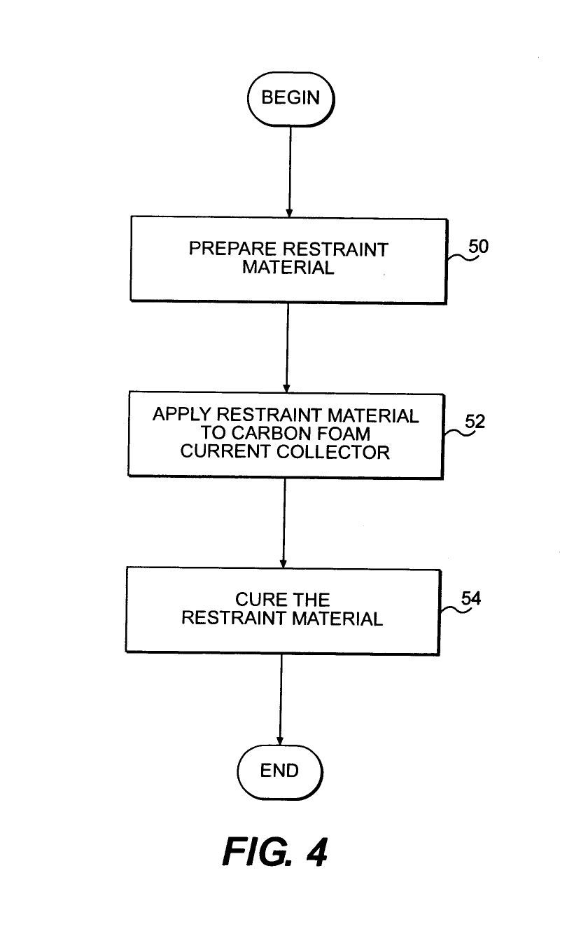

FIG. 4 provides a flow diagram outlining exemplary steps for disposing a physical restraint structure on a carbon foam current collector to produce a structure similar to what is represented by FIG. 3. The first step is to prepare the restraint material, as in step 50. The restraint material can be prepared in a variety of ways. In one embodiment, the restraint material may begin as a polymer (e.g., styrene and/or other suitable polymers) dissolved in a solvent. Possible choices for a solvent include n-methyl pyrrolidone (NMP), methylene chloride, acetone, methyl ethyl keytone, tetrahydrofuran (THF), among others. Solvents differ in their evaporation rates. For example, n-methyl pyrrolidone (NMP) may be used for slow evaporation, while methylene chloride may be used for quick evaporation. The drying time of the restraint material solution may be controlled to achieve desired results by choosing an appropriate solvent.

Any amount of polymer can be added to the solvent to achieve a desired consistency of the mixture. For example, the polymer can be added to the solvent until the mixture reaches a syrup-like consistency. When an appropriate amount of polymer has been added to the solvent and the mixture of solvent and dissolved polymer reaches a desired consistency, the mixture may be rolled onto an applicator (e.g., a glass plate) in preparation for application onto the carbon foam surface. An ink roller may be used in rolling out the mixture. The mixture of dissolved polymer and solvent on the glass substrate creates a thin film of dissolved polymer. The polymer film spread on the glass plate can have any appropriate thickness for providing a desired restraint thickness. In one embodiment, the thickness of the film may be up to about 5 micrometers to maximize the probability that the restraint is disposed only on the ridges and not significantly in the voids of the carbon foam outer surface.

Next, as shown in step 52, the prepared film may be applied to one or more surfaces of the carbon foam. The film may be applied to one primary surface, or alternatively to two opposite primary surfaces. In certain embodiments, one or more edge surfaces of the carbon foam may also receive a coating of the prepared film. To coat the ridges of the carbon foam, a layer of carbon foam may be placed on the glass plate and in contact with the prepared film formed thereon. The film mixture may wet the surface ridges 41 of the foam without significantly filling the surface voids 42 on the carbon foam.

In step 54, the carbon foam coated with the prepared film of restraint material solution can be dried to allow the solvent to evaporate. The coated carbon foam can be air-dried or placed in a furnace for removal of the solvent. As the solvent is removed, the remaining polymer hardens on the outer surface of the carbon foam (e.g., on the ridges 41 of the outer surface) and forms a polymer web-like structure providing restraint on the carbon foam current collector.

The thickness of the polymer disposed on the outer surface of the carbon foam may be chosen to provide a desired level of rigidity and structural restraint to the carbon foam. For example, in one embodiment, the thickness of the polymer coated on the foam (i.e., restraint 33) may be up to about 100 micrometers. In certain embodiments, the desired thickness of the polymer may between about 20 micrometers and 50 micrometers. Multiple applications of the polymer are also permissible.

A second method consistent with FIG. 4 for disposing a physical restraint structure on a carbon foam current collector may also be employed. In this second method the step of preparing the restraint material in step 50 may include melting a polymer rather than dissolving a polymer in a solvent. Various polymers useful for fabricating external restraint 33, such as polyethylene or polypropylene, for example, may be melted.

Melting the polymer and application of the melted polymer according to step 52 may be accomplished by any suitable method. In one embodiment, a sheet of polymer can be placed on a heated plank surface and melted. In another embodiment, a polymer may be melted first in a heating plate or a furnace and then spread onto a surface of, for example, a plank, which may be heated to maintain the melted polymer in its viscous state. Application of the restraint material in step 52 may proceed by exposing the carbon foam to the melted polymer, wherein a portion of the melted polymer is deposited onto one or more surfaces of the carbon foam surface. As in the embodiment described above, the melted polymer of this embodiment may be applied to the surface ridges 41 of the foam, leaving voids 42 substantially free of the melted polymer. At step 54, the melted polymer on the surface of the carbon foam may be cured by, for example, allowing the melted polymer to cool and harden on the surface of the carbon foam to form a web-like structure.

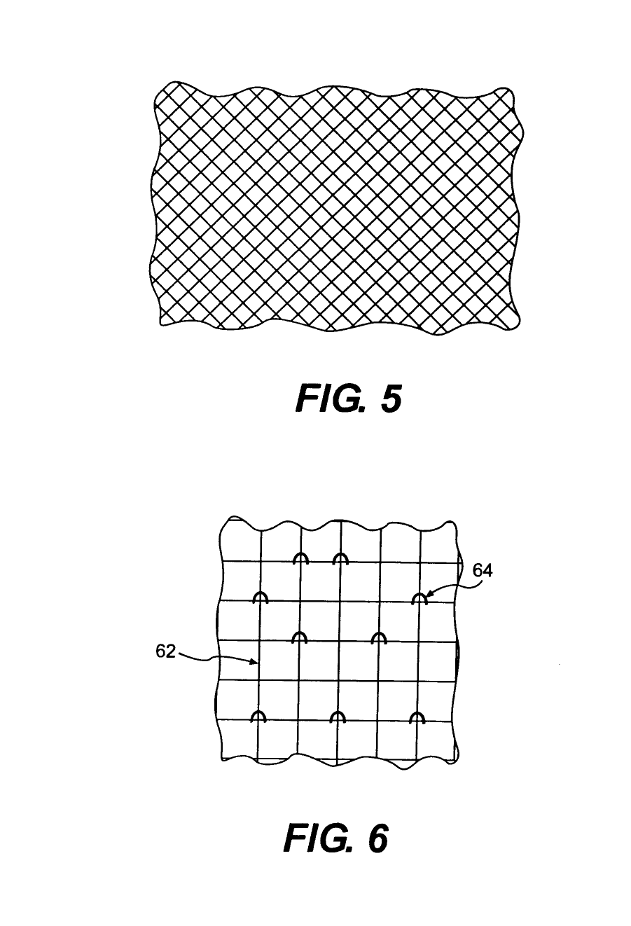

While the embodiments described above include a restraint material 33 formed on one or more surfaces of the carbon foam in a web-like structure, many other suitable configurations of external restraint 33 are possible. For example, external restraint 33 may include a mesh, as diagrammatically illustrated in FIG. 5. Mesh screens used for physical restraint 33 may have about 2 mm square openings, in order to facilitate effective restraining of the carbon foam. A prefabricated mesh restraint structure may be applied to current collector 31 in any suitable manner. For example, mesh screens made of polymer may be used on the two largest sides of the carbon foam to provide physical restraint. In one embodiment, an adhesive may be used to bond the mesh restraint onto current collector. For example, a layer of adhesive may be applied to the mesh restraint and/or current collector 31. The mesh restraint and current collector may then be pressed together under pressure. Optionally, heat may be applied while applying pressure. In another embodiment, the mesh restraint may be applied onto current collector 31 by means of sewing, stapling, or any other suitable mechanical restraining arrangement.

In yet another exemplary embodiment, external restraint 33 may include two grids (e.g., metal or polymer) placed on opposite sides of a carbon foam layer and sewn together or attached by any other suitable means. Such an arrangement is diagrammatically illustrated in FIG. 6. Grids 62 may be made from titanium, aluminum, lead, other types of metals, or various types of polymers, for example. As previously mentioned, according to the orientation of the carbon or graphite foam sheets cut from the bulk material, the larger primary sides of the carbon foam may contain a majority of the surface defects. Therefore, grids 62 may be attached on the two primary sides of the carbon foam for greater restraining effect. The two grids 62 can be sewn together using tungsten wire 64, for example. A reliability test has shown that a carbon foam with a restraint structure as represented by FIG. 6 maintained its structural integrity about twenty times longer, as compared to an unrestrained carbon foam.

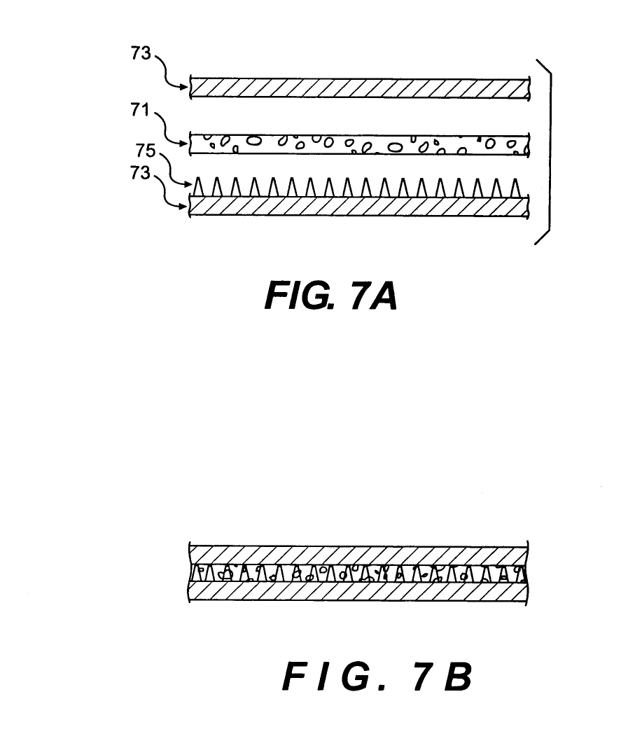

In yet another exemplary embodiment, external restraint 33 may include a three-dimensional interlocking structure, as diagrammatically illustrated in FIG. 7A. Such a structure may be provided, for example, by sheets 73 on outer surfaces of current collector. One or both sheets 73 may include a structure for interlocking with one another. For example, sheets 73 may be configured to include a plurality of spikes, bristles, or other protrusions 75. Sheets 73 may be fabricated from various metals, polymers, or other suitable materials. In one exemplary embodiments, a rigid grid-patterned plastic mesh may be disposed on a first surface of the carbon foam, while a second grid-patterned plastic mesh containing a plurality of protrusions 75 (e.g., spikes or bristles) may be disposed on the other surface opposite to the first surface of carbon foam. Protrusions 75 may be pressed into the carbon foam, impaling the carbon foam in many locations. Protrusions 75 may then be melted onto the grid disposed on the other side of carbon foam, thereby locking the entire structure together in place to produce a restrained structure as diagrammatically represented in cross-section by FIG. 7B.

It will be apparent to those skilled in the art that various modifications and variations can be made to the disclosed materials and processes without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. An electrode plate of an energy storage device comprising:
a carbon foam current collector including a network of pores, the carbon foam current collector having at least one outer surface;
an external restraint structure applied on the at least one outer surface of the carbon foam current collector; and
a chemically active material disposed on the carbon foam current collector, the chemically active material penetrating at least a portion of the network of pores of the carbon foam current collector.

2. The electrode plate of claim 1, wherein the external restraint structure is applied on at least two outer surfaces of the carbon foam current collector.

3. The electrode plate of claim 1, wherein the at least one outer surface of the carbon foam current collector includes a plurality of ridges and voids, and wherein the external restraint structure is disposed on at least some of the ridges of the at least one outer surface of the carbon foam current collector.

4. The electrode plate of claim 3, wherein the external restraint structure includes a polymer web.

5. The electrode plate of claim 3, wherein a thickness of the external restraint structure is between about 10 micrometers and about 100 micrometers.

6. The electrode plate of claim 3, wherein a thickness of the external restraint structure is between about 20 micrometers and about 50 micrometers.

7. The electrode plate of claim 1, wherein the external restraint structure is bonded to the carbon foam current collector.

8. The electrode plate of claim 1, wherein the external restraint structure includes at least two metal grids, the metal grids being sewn together with metallic wire.

9. The electrode plate of claim 1, wherein the external restraint structure includes:
a first member having at least one protrusion that penetrates a first surface of the carbon foam current collector; and
a second member disposed on a second surface of the carbon foam current collector opposite to the first surface,
wherein the at least one protrusion of the first member is configured to couple to the second member through the carbon foam current collector.

10. The electrode plate of claim 1, wherein the external restraint structure includes a mesh screen.

11. The electrode plate of claim 1, wherein the carbon foam current collector includes graphite foam.

12. The electrode plate of claim 1, wherein a thickness of the carbon foam current collector is up to about 2 mm.

13. An energy storage device comprising:
a housing;
a positive terminal and a negative terminal; and
at least one cell disposed within the housing, the cell including:
an electrolytic solution;
at least one positive plate and at least one negative plate connected to the positive terminal and the negative terminal, respectively,
wherein the at least one positive plate includes:
a carbon foam current collector including a network of pores, the carbon foam current collector having at least one outer surface;
an external restraint structure applied on the at least one outer surface of the carbon foam current collector; and
a chemically active material disposed on the carbon foam current collector, the chemically active material penetrating at least a portion of the network of pores of the carbon foam current collector.

14. The energy storage device of claim 13, wherein the external restraint structure includes a polymer web, a metal grid, or a mesh.

15. The energy storage device of claim 13, wherein the external restraint structure is bonded to the carbon foam current collector.

16. The energy storage device of claim 13, wherein the external restraint structure is applied on at least two outer surfaces of the carbon foam current collector.

17. The energy storage device of claim 13, wherein a thickness of the external restraint structure is between about 10 micrometers and about 100 micrometers.

18. The energy storage device of claim 13, wherein a thickness of the external restraint structure is between about 20 micrometers and about 50 micrometers.

19. The energy storage device of claim 13, wherein the carbon foam current collector includes graphite foam.

20. The energy storage device of claim 13, wherein a thickness of the carbon foam current collector is up to about 2 mm.

21. A method for making an electrode plate of an energy storage device comprising:
providing a carbon foam current collector including a network of pores and at least one outer surface, the at least one outer surface including a plurality of ridges and voids;
applying a polymer-based external restraint structure to at least some of the plurality of ridges of the at least one outer surface of the carbon foam current collector; and
applying a chemically active material to the carbon foam current collector.

22. The method of claim 21, wherein the step of applying the external restraint structure to the at least one outer surface of the carbon foam current collector includes:
dissolving the polymer in a solvent to make a solution;
applying the solution to at least some of the ridges of the at least one outer surface of the carbon foam current collector by exposing the carbon foam current collector to the solution; and
drying the carbon foam current collector.

23. The method of claim 21, wherein the step of drying the carbon foam current collector includes applying heat.

24. The method of claim 21, wherein the step of applying the external restraint structure to the at least one outer surface of the carbon foam current collector includes:
melting a polymer;
applying the melted polymer to at least some of the ridges of the at least one outer surface of the carbon foam current collector by exposing the carbon foam current collector to the melted polymer; and
cooling the carbon foam current collector.

25. The method of claim 21, wherein the step of applying the external restraint material includes applying pressure to the carbon foam current collector.
